(19) United States
(12) Patent Application Publication
(10) Pub. No.: US 2026/0273657 A1
(43) Pub. Date: Sep. 17, 2026

(54) POSITIONING SYSTEM AND LASER APPARATUS INCLUDING THE SAME

(71) Applicant: Samsung Display Co., LTD., Yongin-si (KR)

(72) Inventors: YONGHYUN KIM, Yongin-si (KR); SEUNGHO MYOUNG, Yongin-si (KR); KYU-BUM KIM, Yongin-si (KR); JAEHAN KIM, Yongin-si (KR); GYEONGHEE HAN, Yongin-si (KR)

(21) Appl. No.: 19/390,598

(22) Filed: Nov. 16, 2025

(30) Foreign Application Priority Data
Mar. 17, 2025 (KR) 10-2025-0033698

(51) Int. Cl. B23K 26/08; B23K 26/382; B23K 26/70

(52) U.S. Cl. CPC B23K 26/083; B23K 26/382; B23K 26/702

(57) ABSTRACT

A positioning system includes a stage, a plurality of drivers, and a flexure. The plurality of drivers are disposed under a first side and a second side of the stage spaced apart in a first direction, and the drivers are configured to move the stage. The flexure is disposed on the second side of the stage, the first side is rigid, and the flexure is configured to compensate for a positional shift of the stage by varying its structure in response to distortion of the stage.

### CROSS-REFERENCE TO RELATED APPLICATION

This application claims priority to Korean Patent Application 10-2025-0033698, filed on Mar. 17, 2025, and all the benefits accruing therefrom under 35 U.S.C. §119, the content of which in its entirety is herein incorporated by reference.

### BACKGROUND

### 1. Field

The present disclosure relates to a positioning system and a laser apparatus including the positioning system. More specifically, the present disclosure relates to a positioning system for a laser drilling process and a laser apparatus including the positioning system.

### 2. Description of the Related Art

With the development of information technology, the importance of display devices as a medium connecting users and information is increasing. As a result, the use of display devices such as a liquid crystal display device (“LCD”), an organic light emitting display device (“OLED”), and a plasma display device (“PDP”) is increasing.

The manufacturing process of a display device and an electronic device including the display device may include various physical and chemical methods. For example, the manufacturing process of the display device and the electronic device including the display device may include a laser drilling process. The laser drilling process may be a process for processing a substrate using a laser beam. For example, a hole for mounting a camera may be formed through the laser drilling process.

### SUMMARY

Embodiments provide a positioning system having improved precision in a machining position.

Other embodiments provide a laser apparatus comprising the positioning system.

However, the purpose of the disclosure is not limited thereto purpose, and may be expanded in various ways without departing from the spirit and scope of the disclosure.

A positioning system according to embodiments includes: a stage, a plurality of drivers, and a flexure. The plurality of drivers are disposed under a first side and a second side of the stage spaced apart in a first direction and the drivers are configured to move the stage. The flexure is disposed on the second side of the stage, the first side is rigid, and the flexure is configured to compensate for a positional shift of the stage by varying its structure in response to distortion of the stage.

In an embodiment, the flexure may be provided in plurality, and the plurality of flexures may be spaced apart from each other in the first direction or a second direction that intersects the first direction.

In an embodiment, the plurality of flexures may include: a first group of flexures and a second group of flexures spaced apart from each other in the first direction, the first group of flexures includes a first flexure and a second flexure spaced apart from each other in the second direction, and the second group of flexures includes a third flexure and a fourth flexure spaced apart from each other in the second direction.

In an embodiment, at least two of the first flexure, the second flexure, the third flexure, and the fourth flexure may have planar shapes different from each other.

In an embodiment, at least two of the first flexure, the second flexure, the third flexure, and the fourth flexure may have different reaction forces under the same applied force.

In an embodiment, the positioning system may further include a sensor configured to measure position information of the stage.

In an embodiment, the plurality of drivers may be configured to operate based on the position information of the stage.

In an embodiment, the plurality of drivers may be configured to operate differently from each other.

In an embodiment, the plurality of drivers may include: a base; a rail on the base; a guide block configured to move along the rail; and a driving device configured to move the guide block, and the flexure may be disposed between the guide block and the driving device.

A laser processing apparatus according to embodiments includes: a laser source; and a positioning system disposed apart from the laser source, where the positioning system includes: a stage; a plurality of drivers disposed under a first side and a second side of the stage spaced apart in a first direction, and the drivers are configured to move the stage; and a flexure disposed on the second side of the stage, where the first side is rigid, and the flexure is configured to compensate for a positional shift of the stage by varying its structure in response to distortion of the stage.

In an embodiment, the positioning system may be configured to compensate for a gap between a first center and a second center, which is less than or equal to a few micrometers, the first center may indicate a center of a pre-set area to be processed by a laser beam emitted from the laser source, and the second center may indicate a center of an area actually irradiated by the laser beam.

In an embodiment, the laser source may irradiate a laser beam onto an object to be processed disposed on the stage and form a hole in the object to be processed.

In an embodiment, the object to be processed may have a length of tens of meters and a width of several meters.

In an embodiment, the flexure may be provided in plurality, and the plurality of flexures may be spaced apart from each other in the first direction or a second direction that intersects the first direction.

In an embodiment, the plurality of flexures may include: a first group of flexures and a second group of flexures spaced apart from each other in the first direction, the first group of flexures includes a first flexure and a second flexure spaced apart from each other in the second direction, and the second group of flexures includes a third flexure and a fourth flexure spaced apart from each other in the second direction.

In an embodiment, at least two of the first flexure, the second flexure, the third flexure, and the fourth flexure may have planar shapes different from each other.

In an embodiment, at least two of the first flexure, the second flexure, the third flexure, and the fourth flexure may have different reaction forces under the same applied force.

In an embodiment, the laser processing apparatus may further include a sensor configured to measure position information of the stage.

In an embodiment, the plurality of drivers may be configured to operate based on the position information of the stage.

In an embodiment, the plurality of drivers may include: a base; a rail on the base; a guide block configured to move along the rail; and a driving device configured to move the guide block, and the flexure may be disposed between the guide block and the driving device.

In the positioning system and the laser processing apparatus according to embodiments may include the stage, a plurality of drivers, and the flexure. The plurality of drivers may be disposed under a first side and a second side of the stage spaced apart in a first direction, and the drivers may be configured to move the stage. The flexure may be disposed on the second side of the stage, the first side may be rigid, and the flexure may be configured to compensate for a positional shift of the stage by varying its structure in response to distortion of the stage. The first axis of the stage may maintain rigidity to ensure positional precision, while the second axis, which faces the first axis, may provide flexibility through the flexure. Accordingly, loads applied to driving components (e.g., motors, or the like) may be reduced or minimized, and vibrations caused by positional compensation of the stage may be reduced or suppressed. As a result, the machining precision using the laser may be effectively improved.

In addition, the flexure included in the positioning system and the laser processing apparatus may be provided in plurality. The planar shapes of the plurality of flexures may be different from each other. The plurality of flexures may also exhibit different reaction forces in response to an external force. Accordingly, the effect of eliminating or minimizing vibration generation may be maximized, and the machining precision using the laser may be further improved.

In addition, the positioning system and the laser processing apparatus may further include a sensor configured to measure the position information of the stage. The sensor may detect and compensate for a thermal deformation of the stage by the drivers. Accordingly, the position of the stage may be controlled more precisely, and the machining precision using the laser may be further improved.

However, the effect of the disclosure is not limited to the aforementioned effect, and it may be expanded in various ways without deviating from the idea and domain of the disclosure.

### BRIEF DESCRIPTION OF THE DRAWINGS

The above and other features of embodiments of the disclosure will become more apparent by describing in further detail embodiments thereof with reference to the accompanying drawings, in which:

FIGS. 1 and 2 are views illustrating a positioning system and a laser processing apparatus including the positioning system according to embodiments of the disclosure.

FIG. 3 is a perspective view illustrating a laser included in the laser processing apparatus, the positioning system of FIGS. 1 and 2, and an object to be processed by the laser.

FIGS. 4, 5, and 6 are perspective views illustrating a flexure included in the positioning system of the laser processing apparatus of FIGS. 1 and 2.

FIGS. 7, 8, and 9 are plan views illustrating the planar shapes of the flexure shown in FIGS. 4, 5 and 6.

FIGS. 10, 11, and 12 are views illustrating the effects of the positioning system and the laser processing apparatus including the positioning system of FIGS. 1 and 2.

FIG. 13 is a view illustrating a display panel manufactured by the positioning system and the laser processing apparatus including the same of FIGS. 1 and 2.

FIG. 14 is a cross-sectional view along a I-I’ line.

FIG. 15 is a block diagram of electronic devices according to an embodiment.

FIG. 16 is a schematic diagram of an electronic device according to various embodiments.

### DETAILED DESCRIPTION

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Hereinafter, embodiments of the disclosure will be described in greater detail with reference to the accompanying drawings. Same reference numerals will be used for the same components in the drawings, and any repetitive detailed descriptions of the same components will be omitted or simplified.

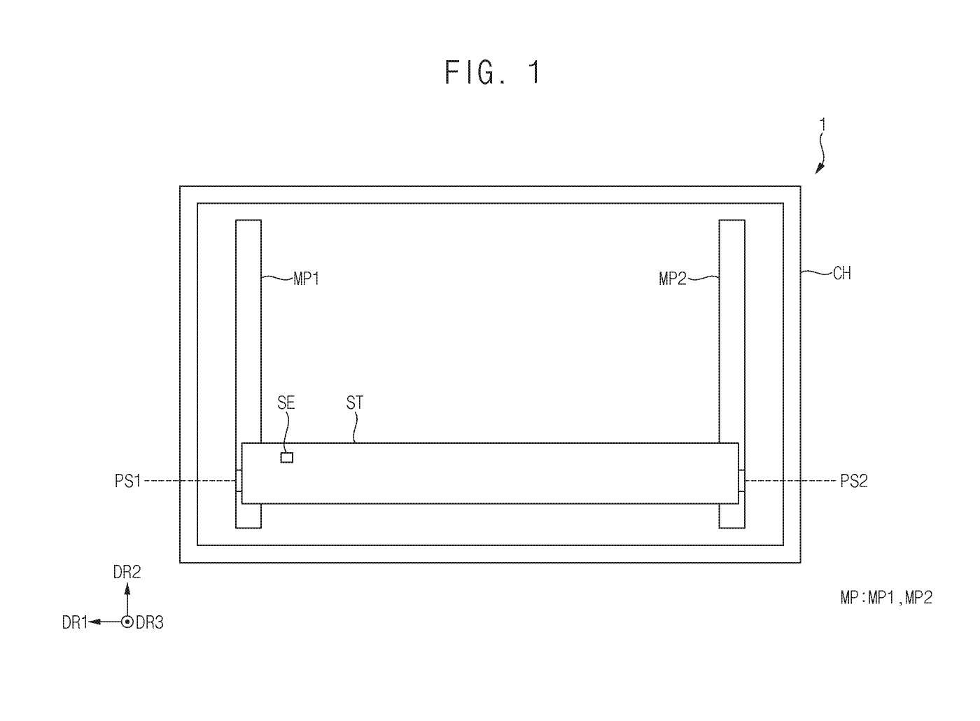

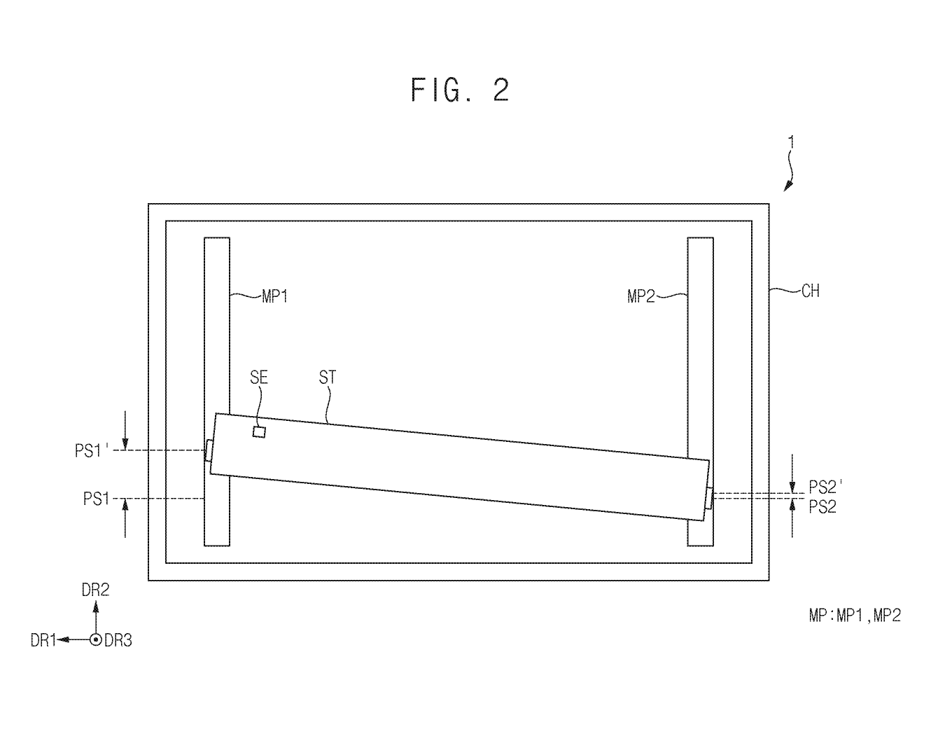

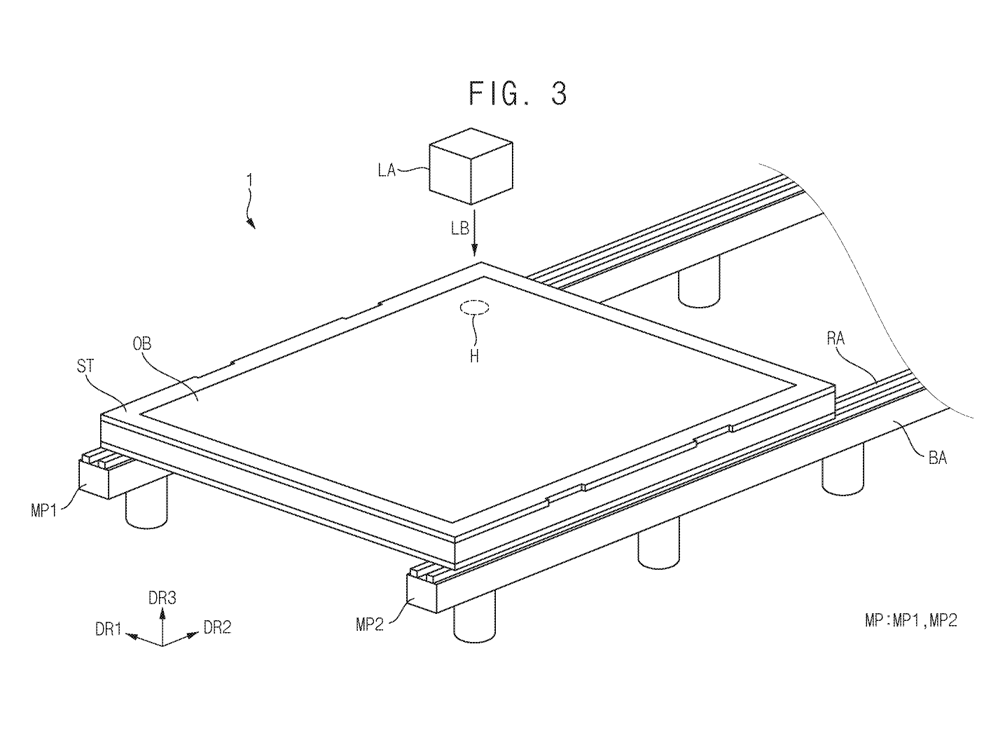

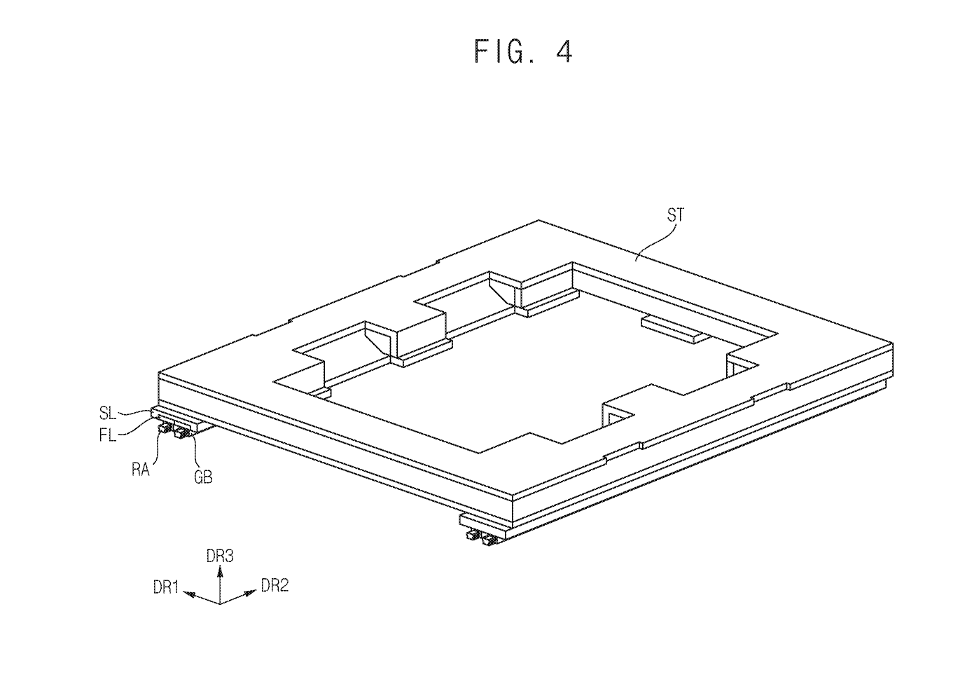

FIGS. 1 and 2 are views illustrating a positioning system and a laser processing apparatus including the positioning system according to embodiments of the disclosure. FIG. 3 is a perspective view illustrating a laser included in the laser processing apparatus, the positioning system of FIGS. 1 and 2, and an object to be processed by the laser. FIGS. 4, 5, and 6 are perspective views illustrating a flexure included in the positioning system of the laser processing apparatus of FIGS. 1 and 2.

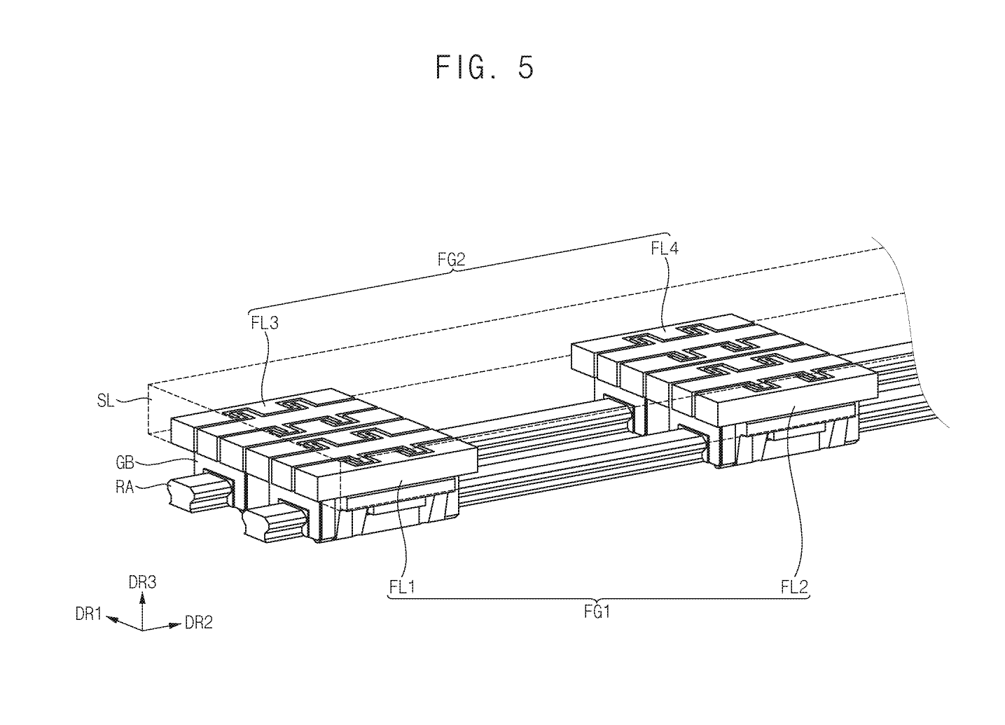

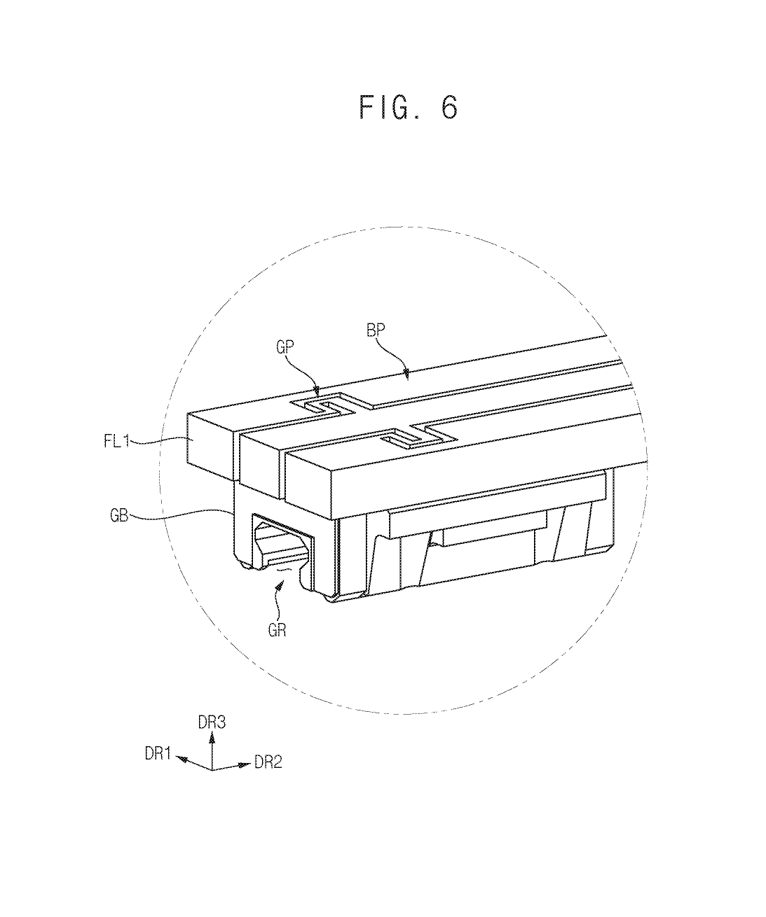

For example, FIGS. 1 and 2 are top views seen through a vacuum chamber CH. For example, FIG. 3 is a view illustrating the positional relationship between an object to be processed OB disposed on a stage ST and a laser source LA arranged above the object to be processed OB. For example, FIG. 4 is an enlarged perspective view of the stage ST illustrating an arrangement position of a flexure FL. FIG. 5 is an enlarged perspective view of a first driver MP1 and the flexure FL disposed on a first axis of the stage ST of FIG. 4. FIG. 6 is an enlarged perspective view of a guide block GB disposed on the first axis of the stage of FIG. 5 and the flexure FL on the guide block GB.

Referring to FIGS. 1, 2, 3, 4, 5, and 6, a laser processing apparatus 1 according to an embodiment of the disclosure may include the laser source LA, the positioning system, and a sensor SE, which are disposed within the vacuum chamber CH.

For example, the laser processing apparatus 1 may be a laser drilling apparatus. The laser drilling apparatus may be an apparatus for non-contact drilling using a laser. The laser drilling apparatus may be faster than a conventional contact drill, and a smaller hole size may be formed, and a cross-section of the hole may be formed smoothly.

For example, the laser source LA may be fixed to the stage ST. The laser source LA may irradiate a laser beam LB towards the stage ST. As the laser source LA is fixed, a focus may be accurately adjusted, so that a fine hole may be precisely formed. In an embodiment, the laser source LA may irradiate onto the laser beam LB to the object to be processed OB disposed on the stage ST to form a hole H in the object to be processed OB.

For example, the laser source LA may be fixed and the stage ST may move. As the stage ST moves, the object to be processed OB also moves, and holes H may be formed at multiple points of the object to be processed OB.

For example, a plurality of the laser source LA may be provided. In this case, the holes H may be formed at multiple points of the object OB at the same time.

For example, the object to be processed OB may have a shape that extends along a plane defined by a first direction DR1 and a second direction DR2. For example, the first direction DR1 and the second direction DR2 may intersect each other. For example, the first direction DR1 and the second direction DR2 may be perpendicular to each other.

For example, the object to be processed OB may be undergo subsequent processing to be manufactured into a display panel (device) or an electronic device including the display panel (device). By moving the stage ST, complex patterns of complex components included in the display panel and the electronic device may be implemented. For example, the object to be processed OB may be manufactured into an electronic device for displaying images, a wearable electronic device, or an automotive electronic device including a display module.

For example, the laser beam LB may be emitted from the laser source LA in a third direction DR3. For example, the third direction DR3 may intersect both the first direction DR1 and the second direction DR2. For example, the third direction DR3 may be perpendicular to both the first direction DR1 and the second direction DR2. Since the laser source LA is fixed, the shaking or vibration of the laser beam LB may be minimized.

In an embodiment, the positioning system may be positioned spaced apart from the laser source LA. The positioning system may include the stage ST, a plurality of drivers MP, and the flexure FL.

For example, the stage ST may be a gantry-type stage. The gantry-type stage ST may be configured to move linearly in a single direction.

The positioning system may include the flexure FL to allow precise position control by utilizing elastic deformation.

For example, as an area of the object to be processed OB increases, a size of the positioning system and the laser processing apparatus 1 including the same may also increase accordingly. For example, the length of the object to be processed OB may be about tens of meters and the width may be about several meters. In this case, the length and the width of the stage ST that supports the object to be processed OB may also be about several to several tens of meters. As the length and the width of the stage ST increase, the stage ST may twist in an angular direction while moving. The machining precision may decrease in proportion to an amount of angular twisting of the stage ST.

For example, if the object to be processed OB includes a substrate for manufacturing the display panel for IT, the machining precision within about several micrometers may be required. If the machining precision is insufficient (i.e., if the machining precision exceeds about several micrometers), the hole H may be formed at an unintended location. Accordingly, the substrate may be determined to be defective and discarded.

In an embodiment, a plurality of drivers MP may be disposed under a first side and a second side of the stage ST spaced apart in the first direction DR1. A plurality of drivers MP may be spaced apart from each other in the first direction DR1. A plurality of drivers MP may move the stage ST to the second direction DR2 intersecting the first direction DR1. For example, a plurality of drivers MP may include a first driver MP1 and a second driver MP2. The first driver MP1 and the second driver MP2 may each have a shape extend along the second direction DR2. For example, the first driver MP1 and the second driver MP2 may be disposed along opposite axes (e.g., first and second sides) of the stage ST. The first driver MP1 and the second driver MP2 may improve the positioning precision of the stage ST with less thrust compared to a laser processing apparatus including a single driver.

In an embodiment, a plurality of drivers MP may include a base BA, a rail RA, the guide block GB, and a driving device SL. The rail RA may be disposed on the base BA. The guide block GB may move along the rail RA. The driving device SL may move the guide block GB.

In an embodiment, the flexure FL may be disposed between one of a plurality of drivers MP and the stage ST. For example, the flexure FL may be disposed between the first driver MP1 and the stage ST, or between the second driver MP2 and the stage ST. In an embodiment, the flexure FL may be disposed between the guide block GB and the driving device SL. For example, the rail RA may be disposed on the base BA, the guide block GB may be disposed on the rail RA, the flexure FL may be disposed on the guide block GB, the driving device SL may be disposed on the flexure FL, and the stage ST may be disposed on the driving device SL. Here, “on” refers to the third direction DR3.

For example, the flexure FL may have different planar levels depending on its location. For example, depending on a structural deformation of the flexure FL, it may have a shape configured to avoid interference with the guide block GB below and the driving device SL above.

The flexure FL may precisely control fine movement of the stage ST through its elastic deformation. Accordingly, precise drilling operations may be enabled.

In an embodiment, the plurality of flexures FL may be provided to be spaced apart in the second direction DR2. In an embodiment, the plurality of flexures FL may include a first group of flexures FG1 and a second group of flexures FG2, which are spaced apart in the first direction DR1. The first group of flexures FG1 may include a first flexure FL1 and a second flexure FL2, which are spaced apart in the second direction DR2. The second group of flexures FG2 may include a third flexure FL3 and a fourth flexure FL4, which are spaced apart in the second direction DR2.

In an embodiment, at least two of the first flexure FL1, the second flexure FL2, the third flexure FL3, and the fourth flexure FL4 may have different planar shapes. In an embodiment, at least two of the first flexure FL1, the second flexure FL2, the third flexure FL3 and the fourth flexure FL4 may have different reaction forces under the same applied force. As used herein, the “planar shape” is a shape in a plan view.

In an embodiment, the flexure FL may change its structure in response to the distortion of the stage ST. Accordingly, the flexure FL may prevent vibrations generated by the movement of a plurality of drivers MP from being transmitted to the stage ST, and may compensate for the position of the stage ST.

In addition, the flexure FL may be capable of absorbing and damping vibration. For example, vibration may occur during the laser drilling operation and/or the movement of the stage ST. The flexure FL may absorb vibration through structural deformation. Accordingly, a more stable drilling operation may be achieved.

In addition, the flexure FL may have low mechanical wear, which may extend the lifespan of the stage ST and reduce the frequency of maintenance.

In an embodiment, the sensor SE may measure the position information of the stage ST. In an embodiment, a plurality of drivers MP may operate based on the position information of the stage ST. In an embodiment, a plurality of drivers MP may operate differently from each other.

For example, the stage ST may include a rigid body. The rigid body may have a small degree of structural deformation (i.e., bending). Accordingly, if the difference in driving displacement between the first driver MP1 and the second driver MP2 is large, a jamming phenomenon may occur in either the first driver MP1 or the second driver MP2. For example, The jamming may occur when the groove GR of the guide block GB becomes engaged with the rail RA and is unable to move.

If the difference in driving displacement between the first driver MP1 and the second driver MP2 is significant, the first driver MP1 and/or the second driver MP2 may become damaged or fail.

In addition, the position information used to control each axis (or each side) may differ from the actual position of the stage ST. For example, the driving displacement instructed by the controller to the first driver MP1 and the second driver MP2 may differ from the actual amount of movement of the stage ST. This discrepancy may be caused by, for example, slight errors in the sensor SE described below, fluctuations in position information due to mechanical friction and wear, or changes in position information resulting from thermal expansion or contraction of mechanical components.

For example, a plurality of drivers MP may include a motor. The motor may accumulate heat generated during operation in the vacuum chamber CH. The stage ST may undergo thermal deformation due to the generated heat. In this case, the stage ST may be disposed at a location different from its intended design location.

The laser beam LB may be irradiated onto the unintended area of the thermally deformed stage ST. In this case, the hole H may be formed by irradiating the laser beam LB onto the unintended area and a defective product may occur.

For example, a first axis (or first side) of the stage ST may be disposed at a first initial position PS1, and a second axis (or second side) of the stage ST facing the first axis may be disposed at a second initial position PS2. As the stage ST moves, the first axis of the stage ST may be disposed at the first correction position PS1’, and the second axis of the stage ST may be disposed at the second correction position PS2’. A gap between the first initial position PS1 and the first correction position PS1’ may be different from a gap between the second initial position PS2 and the second correction position PS2’. As more heat accumulates in the stage ST, the difference between the two gaps may further increase.

The positioning system and the laser processing apparatus 1 including the positioning system, according to embodiments of the disclosure, may include the stage ST, a plurality of drivers MP, and the flexure FL. A plurality of drivers MP may be disposed under the stage ST, spaced apart from each other in the first direction DR1, and configured to move the stage ST in the second direction DR2 intersecting the first direction DR1. The Flexure FL may be disposed between one of a plurality of drivers MP and the stage ST. As flexure FL changes its structure in response to the distortion of the stage ST, it may prevent vibration generated by the movement of a plurality of drivers MP from being transmitted to the stage ST, and may compensate for the position of the stage ST. Accordingly, the second axis (or second side) of the stage ST, which is not adjacent to the flexure FL, may maintain rigidity for accuracy, while the first axis (or first side) facing the second axis and adjacent to the flexure FL may provide flexibility using the flexure FL, thereby reducing or minimizing the load applied to the driving components (e.g., motor, or the like.). In addition, vibration caused by position compensation of the stage ST may also be reduced or minimized. As a result, the machining precision using the laser (e.g., laser beam LB emitted from the laser source LA) may be improved.

In an embodiment, the sensor SE may detect thermal deformation of the stage ST caused by a plurality of drivers MP and compensate for the thermal deformation. A plurality of drivers MP may operate differently from each other. The stage ST may be controlled to prevent rotation in a plane parallel to the plane defined by the first direction DR1 and the second direction DR2. For example, in a subsequent operation of FIG. 2, the first driver MP1 may move the stage ST by a smaller amount than the second driver MP2. Accordingly, the distortion of the stage ST may be minimized. By controlling the position of the stage ST more precisely, the machining precision using the laser (e.g., laser beam LB emitted from the laser source LA) may be further improved.

In an embodiment, in addition, the positioning system and the laser processing apparatus 1 may include the plurality of flexures FL. In an embodiment, each of the flexures FL on the guide blocks GB of FIG. 5 may have different planar shapes. For example, at least two of the first flexure FL1, the second flexure FL2, the third flexure FL3, and the fourth flexure FL4 may have different planar shapes.

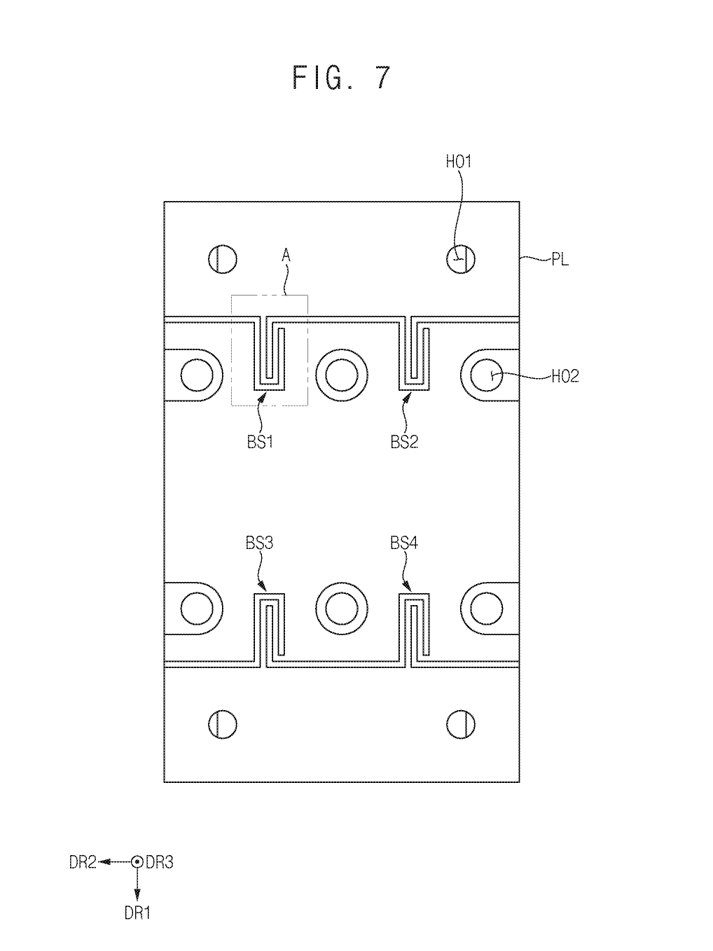

For example, as shown in FIG. 6, the flexure FL may have a structure in which a bend part GP is formed on a base plate BP. For example, as shown in FIGS. 5 and 6, if a plurality of bend parts GP are formed within a single flexure FL, at least two of the plurality of the bend parts GP (e.g., refer to BS1, BS2, BS3, and BS4 of FIG. 7) may have different planar shapes.

The planar shape may be variously designed and changed depending on the reaction force required during the laser processing operation.

FIGS. 7, 8 and 9, are plan views illustrating the planar shapes of the flexure shown in FIGS. 4, 5 and 6. As used herein, the plan view of flexure is a view in a thickness direction (i.e., third direction DR3) of the flexure.

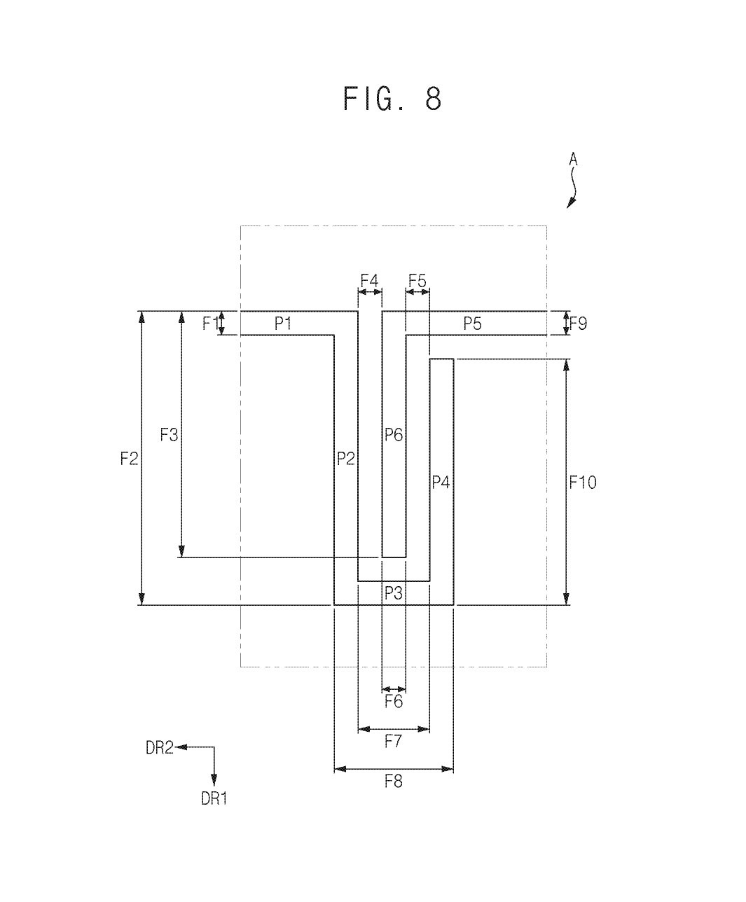

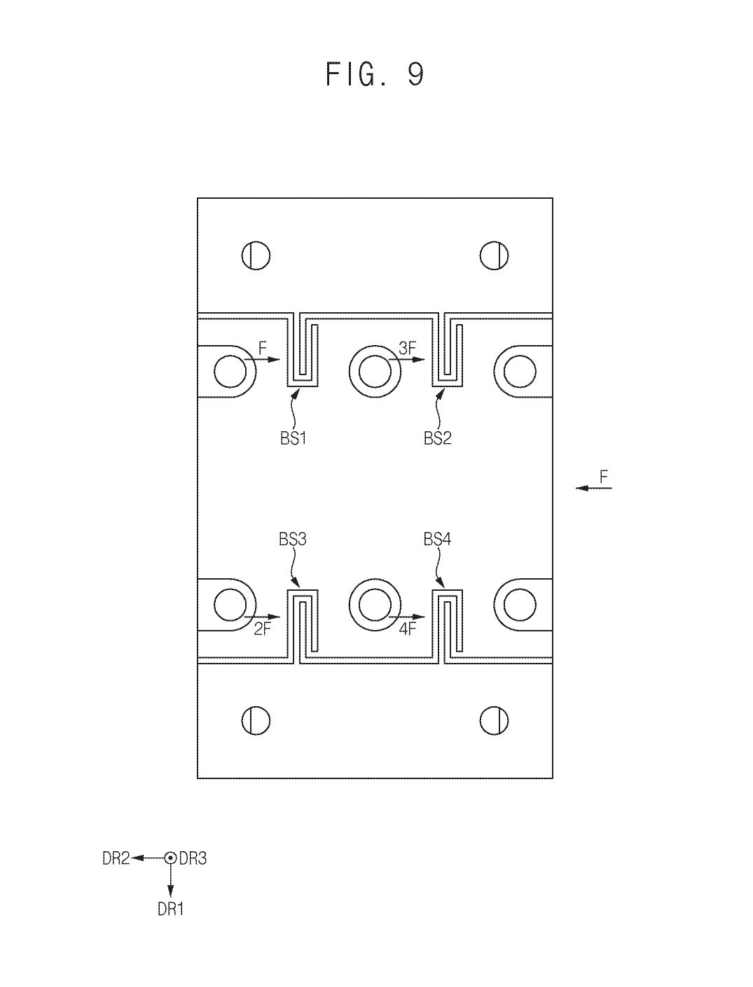

For example, FIG. 8 is an enlarged view of the A part of FIG. 7. FIG. 9 shows an example of how the flexures of FIG. 7 operate with different reaction forces.

Referring to FIGS. 1, 2, 3, 6, 7, 8, and 9, in an embodiment, the planar shapes of the plurality of flexures FL may differ from each other. In addition, the planar shape of the plurality of bend parts GP within the single flexure FL may also differ from each other. For example, a first planar shape BS1, a second planar shape BS2, a third planar shape BS3, and a fourth planar shape BS4 of the bend parts GP may differ from each other. Accordingly, the plurality of flexures FL may have different reaction forces (e.g., F, 2F, 3F, and 4F in the right direction of FIG. 9) in response to the external force (e.g., F in the left direction of FIG. 9).

For example, the plurality of flexures FL may include a first part P1, a second part P2, a third part P3, a fourth part P4, a fifth part P5, and a sixth part P6. For example, the first part P1 may have a shape extended in the second direction DR2. The second part P2 may extend from the first part P1 and have a shape extending in the first direction DR1 which intersects the first part P1. The third part P3 may extend from the second part P2 and have a shape extending in the second direction DR2, which intersects the second part P2. The fourth part P4 may extend from the third part P3 and have a shape extending in the first direction DR1, which intersects the third part P3.

For example, the first part P1 may have a first width F1 in the first direction DR1 and a first length in the second direction DR2. For example, the second part P2 may have a second width in the second direction DR2 and a second length F2 in the first direction DR1. For example, the third part P3 may have a third width in the first direction DR1 and a third length F8 in the second direction DR2. For example, the fourth part P4 may have a fourth width in the second direction DR2 and a fourth length F10 in the first direction DR1.

For example, the fifth part P5 may have a shape extending in the second direction DR2. The sixth part P6 may extend from the fifth part P5 and have a shape extending in the first direction DR1 intersecting the fifth part P5.

For example, the fifth part P5 may have a fifth width F9 in the first direction DR1 and a fifth length in the second direction DR2. For example, the sixth part P6 may have a sixth width F6 in the second direction DR2 and a sixth length F3 in the first direction DR1.

For example, the fifth part P5 and the sixth part P6 may be disconnected from the first part P1, the second part P2, the third part P3, and the fourth part P4. For example, a gap F4 between the first part P1 and the fifth part P5, a gap F7 between the second part P2 and the fourth part P4, and a gap F5 between the fourth part P4 and the sixth part P6, or the like may be different from each other.

For example, if the planar shape of the plurality of flexures FL is the same, substantially the same reaction forces may be generated in response to the external force F. In this case, vibration may be transmitted to the stage ST disposed on the plurality of flexures FL, causing the stage ST to become unstable.

However, in the case of the positioning system and the laser processing apparatus 1 including the positioning system according to embodiments of the disclosure, the plurality of flexures FL may have different reaction forces in response to the external force F, and the transmission of vibration to the stage ST disposed on the plurality of flexures FL may be minimized or prevented. Accordingly, the movement of the stage ST may become more stable.

For example, the reaction force of the flexure FL may vary depending on its length and width. For example, the longer the length and the narrower the width, the smaller the reaction force may be.

The planar shape of the plurality of flexures FL may be variously designed and changed depending on material rigidity, material thickness, size and structural elements (holes, or the like), magnitude and direction of the applied load, position of the applied load, temperature variations, or the like.

In addition, the number and arrangement of flexures FL may be variously changed. For example, if the stage ST is small, the flexure FL may include only single row. For example, only the first group of flexures FG1 or the second group of flexures FG2 shown in FIG. 5 may be included. For another example, as the size of stage ST increases, the number of flexures FL may also increase.

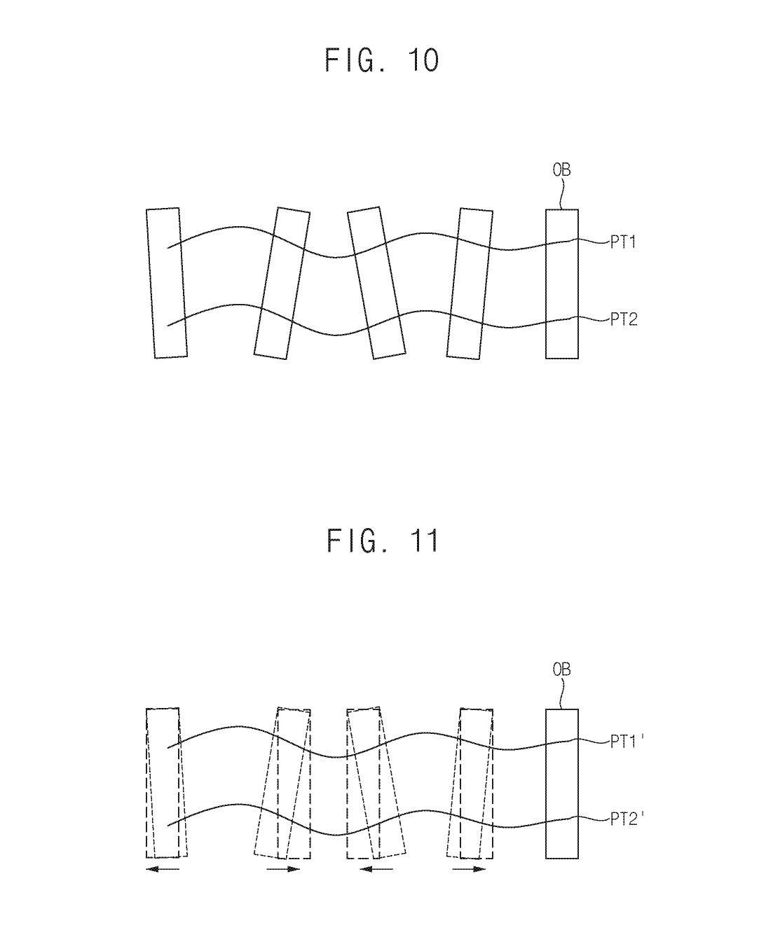

FIGS. 10, 11, and 12 are views illustrating the effects of the positioning system and the laser processing apparatus including the positioning system of FIGS. 1 and 2.

For example, FIG. 10 illustrates the movement of the object to be processed OB in the laser processing apparatus according to a comparative embodiment. As shown in FIG. 10, the laser processing apparatus of the comparative embodiment does not include the flexure FL in both axes (e.g., a first axis PT1 and a second axis PT2). In this case, the object to be processed OB might not move linearly but may instead be tilted and move in an angular direction. The amount of angular deviation may result in a machining error.

Since the flexure FL is not included, if the two axes are controlled differently to compensate for the misalignment, a malfunction may occur due to over-constraint on one of the axes, or issues such as component failure may occur.

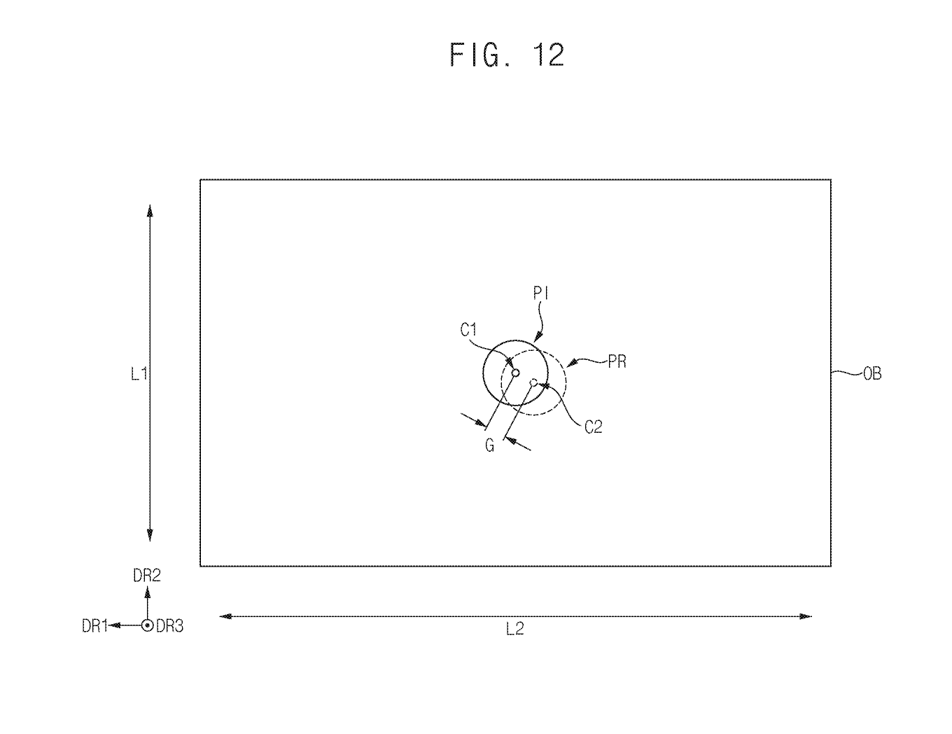

For example, FIG. 11 illustrates the compensated movement of the object to be processed OB in the laser processing apparatus according to embodiments of the disclosure. Referring to FIG. 11, the laser processing apparatus according to embodiments of the disclosure may include the flexure FL on one axis (e.g., a first axis PT1’ or a second axis PT2’). In this case, the flexure FL may undergo structural deformation in response to the tilting of the object to be processed OB, thereby compensating for the misalignment. Accordingly, the machining error may be reduced or minimized.

In other words, one axis that does not include the flexure FL may have rigidity to precisely control the stage ST, and the other axis that includes the flexure FL may provide flexibility to relieve over-constraint during posture correction of the stage ST and to prevent vibration caused by a plurality of drivers MP from being transmitted to the stage ST.

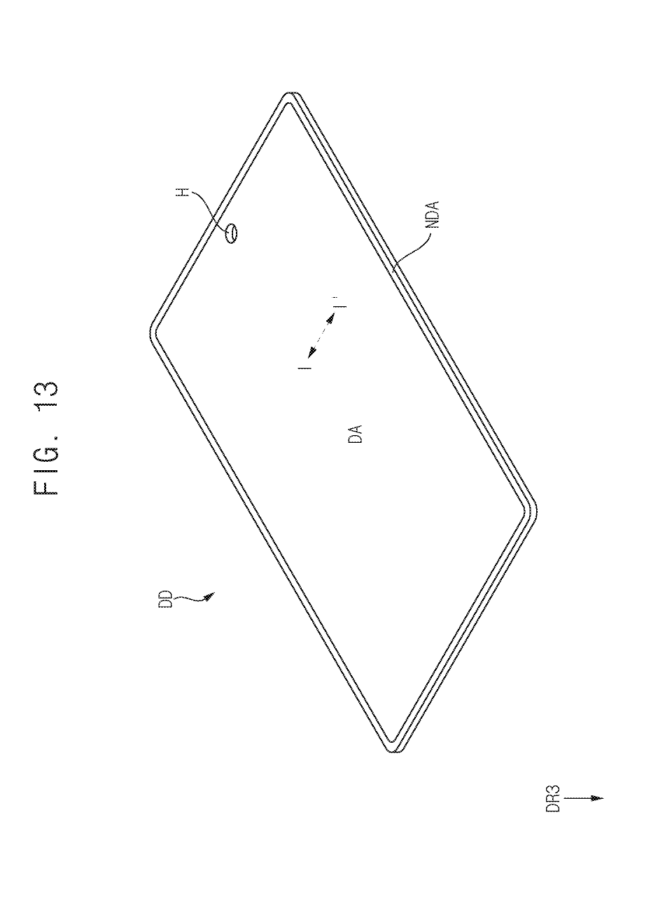

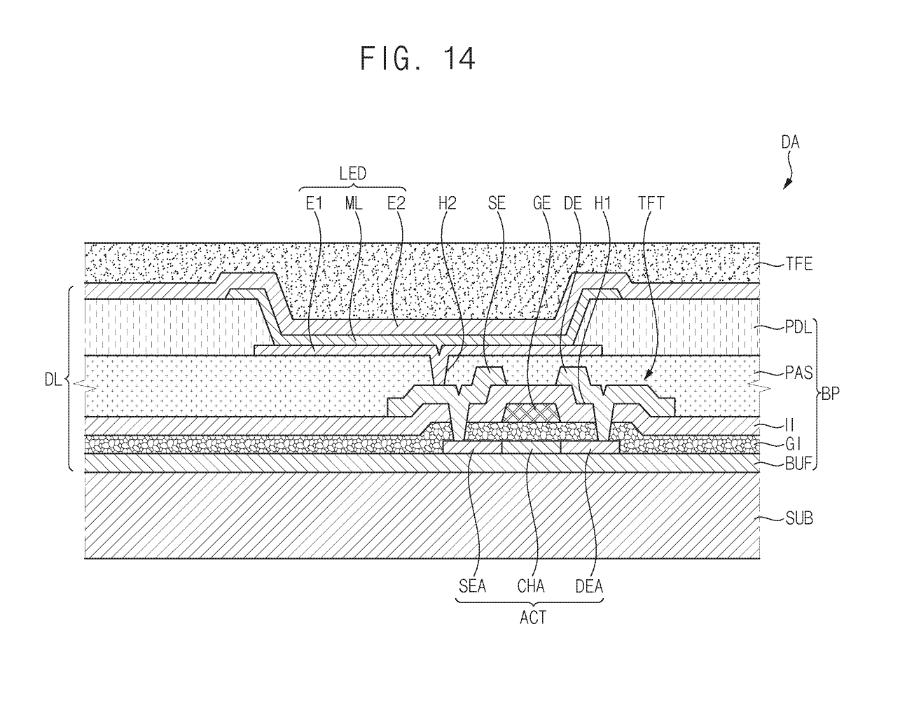

For example, FIG. 12 is a view illustrating the machining error. Referring to FIGS. 1, 2, 3, and 12, in an embodiment, the laser source LA may irradiate the laser beam LB onto the object to be processed OB disposed on the stage ST to form the hole (e.g., the hole H of FIG. 13) in the object to be processed OB.

In an embodiment, the length L1 of the object to be processed OB may be about several tens of meters (“m”), and the width L2 may be about several meters. (In other words, the laser processing apparatus 1 may be a processing apparatus for a large substrate.)

In an embodiment, the positioning system may compensate for a gap G between a first center C1 and a second center C2 to about a few micrometers (“um”) or less. The first center C1 may refer to a center of a pre-set region PI to be processed by the laser beam LB emitted from the laser source LA. The second center C2 may refer to a center of an area PR where the laser beam LB is actually irradiated.

If the object to be processed OB is a large-area object, the object to be processed OB might not move linearly and may move in the angular direction in response to a processing surface (e.g., the plane defined by the first direction DR1 and the second direction DR2). For example, the object to be processed OB may rotate with respect to the axis parallel to the first direction DR1, or it may rotate about an axis parallel to the second direction DR2. For example, the laser processing apparatus according to the comparative embodiment may have the gap G between the first center C1 and the second center C2 of about tens of micrometers. For example, the laser processing apparatus according to the comparative embodiment may have a machining precision of about 10 micrometers.

However, the positioning system and the laser processing apparatus including the positioning system according to embodiments of the disclosure may compensate for the position of the stage ST when the object to be processed OB is twisted in the angular direction with respect to the processing surface. Accordingly, the positioning system and the laser processing apparatus including the positioning system according to embodiments of the disclosure, the gap G between the first center C1 and the second center C2 may be reduced to about a few micrometers or less. For example, the positioning system and the laser processing apparatus including the positioning system according to embodiments of the disclosure may have a machining precision of about 5 micrometers. (In other words, compared to the laser processing apparatus according to the comparative embodiments, the positioning system and the laser processing apparatus including the positioning system according to embodiments of the disclosure, the machining precision may have improved machining precision by about 50%).

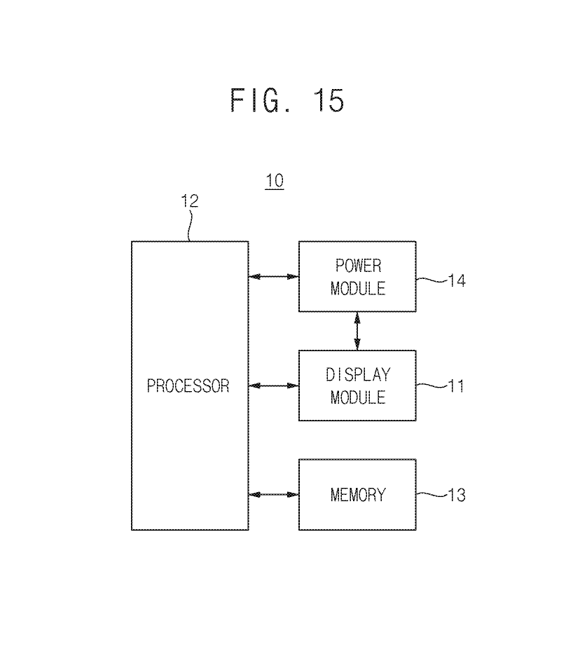

FIG. 13 is a view illustrating a display panel manufactured by the positioning system and the laser processing apparatus including the same of FIGS. 1 and 2. FIG. 14 is a cross-sectional view along a I-I’ line.

Referring to FIGS. 13 and 14, a display device DD may display an image. For example, the display device DD may include an organic light-emitting display panel, a liquid crystal display panel, a quantum dot display panel, a micro-LED display panel, a nano-LED display panel, or the like. However, the disclosure is not limited thereto.

The display device DD may include a display area DA and a peripheral area NDA. For example, an image may be displayed in the display area DA. A plurality of pixels may be disposed in the display area DA. The front may refer to the surface on which the light emitted from the plurality of pixels is displayed as an image. The front and back may be spaced in the third direction DR3.

The peripheral area NDA may surround the display area DA. For example, the shape of the display area DA may be substantially defined by the peripheral area NDA.

For example, the hole H formed in the display device DD may be formed at a position that overlaps with a camera. For example, the hole H may be formed using the laser processing apparatus 1 described in FIGS. 1 and 2. However, the disclosure is not limited thereto. For example, the laser processing apparatus 1 may be used in various laser processing processes required to manufacture the display device DD.

FIG. 13 describes the planar shape of the display area DA as a rectangle with cut edges, however, the disclosure is not limited thereto. For example, the planar shape of the display area DA may be of various shapes, such as circular, oval, rectangle, square, or the like.

The display device DD may be formed by layering a plurality of layers on a base substrate SUB. For example, a pixel included in the display panel PA may include the base substrate SUB, a buffer layer BUF, a displaying layer DL, and an encapsulation layer TFE.

The displaying layer DL may include a transistor TFT, a gate insulating layer GI, an interlayer insulating layer II, a passivation layer PAS, a light-emitting element LED, and a pixel defining layer PDL.

The display area DA may include a light-emitting region and a non-light-emitting region. For example, the transistor TFT and the light-emitting elements LED may be located in the light-emitting region.

For example, the transistor TFT may include an active layer ACT, a gate electrode GE, a source electrode SE, and a drain electrode DE. The light-emitting element LED may include a first electrode E1, an intermediate layer ML, and a second electrode E2.

The non-light-emitting region may surround the light-emitting region in a plan view. Here, the plan view may refer to a view along the third direction DR3.

For example, the base substrate SUB may include glass, quartz, plastic, SUS, titanium (“Ti”), or the like. For example, the base substrate SUB may have flexible, bend-able, or roll-able properties.

The buffer layer BUF may be disposed on the base substrate SUB. The buffer layer BUF may include an inorganic insulating material. For example, the buffer layer BUF may include silicon oxide, silicon nitride, silicon oxynitride, or the like. The buffer layer BUF may prevent an impurity from being diffused into or damaging the active layer ACT of the transistor TFT. However, the disclosure is not limited thereto. For example, the buffer layer BUF may include an organic insulating material.

The active layer ACT may be disposed on the buffer layer BUF. According to an embodiment, the active layer ACT may include a silicon semiconductor material. For example, the active layer ACT may include amorphous silicon, polycrystalline silicon, or the like. According to an embodiment, the active layer ACT may include oxide semiconductor material. For example, the active layer ACT may include zinc oxide, zinc-tin oxide, zinc-indium-oxide, indium-oxide, titanium-oxide, indium-gallium-zinc-oxide, indium-zinc-tin-oxide, or the like. According to an embodiment, the active layer ACT may include an organic semiconductor material.

The active layer ACT may include a source region SEA, a drain region DEA, and a channel region CHA that is interposed between the source region SEA and the drain region DEA.

For example, the active layer ACT may be formed by forming an amorphous silicon layer on the buffer layer BUF, crystallizing the amorphous silicon layer, and patterning the crystallized silicon layer. For example, the active layer ACT may be doped with impurities in the source region SEA and drain region DEA, depending on a type of the transistor TFT (for example, driving transistor, switching transistor, or the like).

The gate insulating layer GI may be disposed on the active layer ACT. The gate insulating layer GI may include an inorganic insulating material. For example, the gate insulating layer GI may include silicon oxide, silicon nitride, silicon oxide, titanium-oxide, tantalum oxide, or the like. The gate insulating layer GI may electrically insulate the active layer ACT from the gate electrode GE from each other.

The gate electrode GE may be disposed on the gate insulating layer GI. The gate electrode GE may include a conductive material. For example, the gate electrodes GE may include a metal, an alloy, a conductive metal oxide, a transparent conductive material, or the like. The gate electrodes GE may be applied with a gate signal. The gate signal may turn on/off the transistor TFT to adjust an electrical conductivity of the active layer ACT.

The interlayer insulating layer II may be disposed on the gate electrode GE. The interlayer insulating layer II may include an organic and/or an inorganic insulating material. The interlayer insulating layer II may electrically insulate the source electrode SE and the drain electrode DE from the gate electrode GE.

The source electrode SE and drain electrode DE may be disposed on the interlayer insulating layer II. The source electrode SE and the drain electrode DE may include a conductive material. For example, the source electrode SE and the drain electrode DE may include a metal, an alloy, a conductive metal oxide, a transparent conductive material, or the like.

The source electrode SE and drain electrode DE may be in electrical contact with the active layer ACT through a contact hole H1 defined or formed through the interlayer insulating layer II and the gate insulating layer GI. For example, the source electrode SE may be connected to the source region SEA and the drain electrode DE may be connected to the drain region DEA through a contact hole H1 in the interlayer insulating layer II and gate electrode GE.

The passivation layer PAS may be disposed on the source electrode SE and the drain electrode DE. The passivation layer PAS may include an organic insulating material. For example, the passivation layer PAS may include a polyacrylic resin, a polyimide-based resin, an acrylic-based resin, or the like. A top surface of the passivation layer PAS may be substantially flat. For example, the passivation layer PAS may be formed with a transparent insulator to achieve a resonant effect. For example, the passivation layer PAS may include two or more layers including organic and/or inorganic matter. However, the disclosure is not limited thereto.

In another embodiment, for example, the top surface of the passivation layer PAS may be formed to bend according to a curvature of an underlying layer. In this case, the passivation layer PAS may also include an inorganic insulating material.

The first electrode E1 may be disposed on the passivation layer PAS. The first electrode E1 may include a conductive material. For example, the first electrode E1 may include a metal, an alloy, a conductive metal oxide, a transparent conductive material, or the like.

The first electrode E1 may be electrically connected to the source electrode SE or the drain electrode DE through a contact hole H2 defined or formed through the passivation layer PAS. According to an embodiment, the first electrode E1 may be referred to as an anode electrode.

The pixel defining layer PDL may be disposed on the passivation layer PAS and cover a portion of the first electrode E1. The pixel defining layer PDL may include an organic insulating material. For example, the pixel defining layer PDL may include a polyacrylic compound, a polyimide-based compound, or the like. The pixel defining layer PDL may define or be provided with a pixel opening to partition the light-emitting region of the pixel. The pixel opening defined in the pixel defining layer PDL may extend to the first electrode E1.

The intermediate layer ML may be disposed on the first electrode E1 in the pixel opening. The intermediate layer ML may include an organic light-emitting material. According to an embodiment, the intermediate layer ML may have a multi-layered structure including various functional layers. For example, the intermediate layer ML may include at least one of a hole injection layer, a hole transport layer, an electron transport layer, or an electron injection layer.

The second electrode CE may be disposed on the intermediate layer ML and cover the pixel defining layer PDL. According to an embodiment, the second electrode CE may be referred to as a cathode electrode.

In addition, the intermediate layer ML and the second electrode E2 may be formed on the first electrode E1.

The first electrode E1 and the second electrode E2 may be separated from each other by the intermediate layer ML, and light may be emitted from the organic light-emitting layer by applying voltages of different polarities to the intermediate layer ML. In an embodiment, a unit pixel may include a plurality of sub pixels, and the plurality of sub pixels may emit light of various colors. For example, each of the plurality of sub pixels may emit any one of red, green, or blue lights. However, the disclosure is not limited thereto. In another embodiment, for example, the plurality of sub pixels may emit white light.

The encapsulation layer TFE may have a multi-layered structure. For example, the encapsulation layer TFE may include at least one organic layer interposed between at least two inorganic layers. For example, the encapsulation layer TFE may include at least one inorganic layer interposed between at least two organic layers. For example, the encapsulation layer TFE may include at least an organic layer interposed between at least two inorganic layers, and at least an inorganic layer interposed between at least two organic layers.

For example, the encapsulation layer TFE may include an organic layer. For example, the organic layer may include a polymer. For example, the polymer may include polyethylene terephthalate, polyimide, polycarbonate, epoxy, polyethylene, polyacrylate, or the like. Each of them may be used alone or in combination with each other. However, the disclosure is not limited thereto. The organic layer may include a material polymerized monomer composition. For example, the monomer composition may include a mono-acrylate-based monomer, a de-acrylate-based monomer, a tri-acrylate-based monomer, a photo-initiator such as 2,4,6-tri-methylbenzoyl-diphenyl phosphine oxide (“TPO”), or the like. Each of them may be used alone or in combination with each other. However, the disclosure is not limited thereto.

For example, the encapsulation layer TFE may include an inorganic layer. For example, the inorganic layer may include a metal oxide or a metal nitride. For example, the inorganic layer may include SiNₓ, Al₂O₃, SiO₂, TiO₂, or the like. The materials listed above may be used alone or in combination with each other. However, the disclosure is not limited thereto.

For example, the encapsulation layer TFE may include a first inorganic layer, a first organic layer, and a second inorganic layer sequentially stacked from a top of the light-emitting element LED. For example, the encapsulation layer TFE may include the first inorganic layer, the first organic layer, the second inorganic layer, a second organic layer, and a third inorganic layer sequentially stacked from the top of the light-emitting element LED. For example, the encapsulation layer TFE may include the first inorganic layer, the first organic layer, the second inorganic layer, the second organic layer, the third inorganic layer, a third organic layer, and the fourth inorganic layer sequentially stacked from the top of the light-emitting element LED.

A top layer of the encapsulation layer TFE that is the outermost layer of the display panel PA may be formed with the inorganic layer to prevent the moisture permeation into the light-emitting element LED. However, the disclosure is not limited thereto.

A halide-metal layer may be further included between the light-emitting element LED and the first inorganic layer. For example, the halide-metal layer may include lithium fluoride (“LiF”). In the case that the first inorganic layer is formed by sputtering method, the halide-metal layer may effectively prevent the light-emitting element LED from being damaged. However, the disclosure is not limited thereto.

FIG. 15 is a block diagram of electronic devices according to an embodiment.

The display device according to the embodiment may be applied to various electronic devices. An electronic device in an embodiment includes the above-described display apparatus and may include additional modules or devices having other additional functions in addition to the display device.

Referring to FIG. 15, an electronic device EA according to an embodiment may include a display module DM, a processor PC, a memory ME, and a power module PM.

The processor PC may include a central processing unit (“CPU”), an application processor (“AP”), a graphic processing unit (“GPU”), a communication processor (“CP”), an image signal processor (“ISP”), and/or a controller.

Data information used for operation of the processor PC or the display module DM may be stored in the memory ME. When the processor PC executes an application stored in the memory ME, an image data signal and/or an input control signal is transmitted to the display module DM, and the display module DM may process received signal and output image information through a display screen.

The power module PM may include a power supply module such as a power adapter and/or a battery device, and a power conversion module that converts power supplied by the power supply module to generate power used for operation of the electronic device EA.

At least one of the components of the electronic device EA described above may be included in the display device according to the above-described embodiments. In addition, some of individual modules functionally included in one module may be included in the display device, and others may be provided separately from the display device. For example, the display device may include the display module DM, and the processor PC, the memory ME, and the power module PM may be provided in the form of another device in the electronic device EA other than the display device. In an embodiment, the display device may operate based on the image data signal and the input control signal.

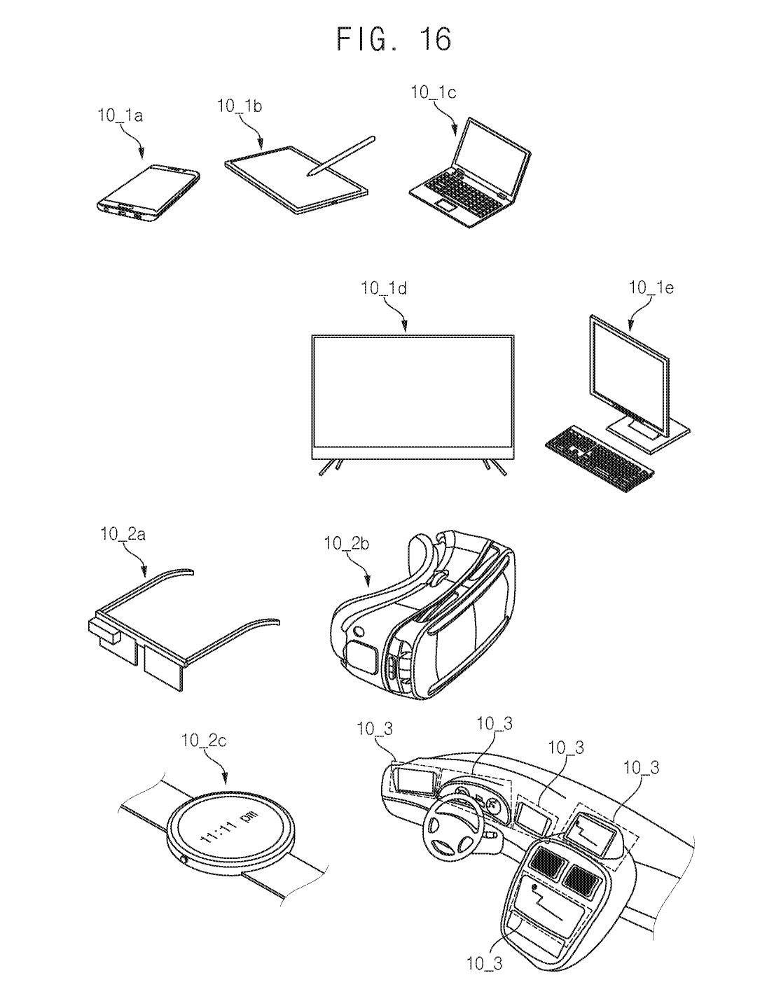

FIG. 16 is a schematic diagram of an electronic device according to various embodiments.

Referring to FIG. 16, one or more suitable electronic devices to which display devices according to an embodiment are applied may include not only electronic devices for image display such as a smartphone 10_1a, a tablet personal computer (“PC”) 10_1b, a laptop 10_1c, a television (“TV”) 10_1d, a desk monitor 10_1e, and/or the like, but wearable electronic devices including display modules such as a smart glass 10_2a, a head mounted display 10_2b, a smart watch 10_2c, and/or the like, vehicle electronic device 10_3 including display modules such as on a vehicle's instrument panel, a center fascia, a center information display (“CID”) located on a dashboard, a room mirror display, and/or the like.

The object to be processed manufactured by the positioning system and a laser processing apparatus including the same may be applied to a computer, a notebook, a mobile phone, a smartphone, a smart pad, a portable media player (“PMP”), a personal digital assistance (“PDA”), an MP3 player, or the like.

The display device according to the embodiment and the electronic device including the same are explained with reference to the diagram, but the embodiment illustrated is an example, and a person with ordinary knowledge of the relevant technical field understands that the disclosure may be modified and modified in various ways within the scope of the idea and area of the disclosure described in the patent claims below.

What is claimed is:

1. A positioning system comprising:
a stage;
a plurality of drivers disposed under a first side and a second side of the stage spaced apart in a first direction, wherein the drivers are configured to move the stage; and
a flexure disposed on the second side of the stage, wherein the first side is rigid, and the flexure is configured to compensate for a positional shift of the stage by varying a structure of the flexure in response to distortion of the stage.

2. The positioning system of claim 1, wherein the flexure is provided in plurality, and the plurality of flexures are spaced apart from each other in the first direction or a second direction that intersects the first direction.

3. The positioning system of claim 2, wherein the plurality of flexures includes:
a first group of flexures and a second group of flexures, which are spaced apart from each other in the first direction,
the first group of flexures includes a first flexure and a second flexure, which are spaced apart from each other in the second direction, and
the second group of flexures includes a third flexure and a fourth flexure, which are spaced apart from each other in the second direction.

4. The positioning system of claim 3, wherein at least two of the first flexure, the second flexure, the third flexure, and the fourth flexure have planar shapes different from each other.

5. The positioning system of claim 3, wherein at least two of the first flexure, the second flexure, the third flexure, and the fourth flexure have different reaction forces under a same applied force.

6. The positioning system of claim 1, further comprising:
a sensor, which measures position information of the stage.

7. The positioning system of claim 6, wherein the plurality of drivers operate based on the position information of the stage.

8. The positioning system of claim 1, wherein the plurality of drivers operate differently from each other.

9. The positioning system of claim 1,
wherein the plurality of drivers includes:
a base;
a rail on the base;
a guide block, which moves along the rail; and
a driving device, which moves the guide block, and
wherein the flexure is disposed between the guide block and the driving device.

10. A laser processing apparatus comprising:
a laser source; and
a positioning system disposed apart from the laser source, the positioning system comprising:
a stage;
a plurality of drivers disposed under a first side and a second side of the stage spaced apart in a first direction, wherein the drivers are configured to move the stage; and
a flexure disposed on the second side of the stage, wherein the first side is rigid, and the flexure is configured to compensate for a positional shift of the stage by varying a structure of the flexure in response to distortion of the stage.

11. The laser processing apparatus of claim 10, wherein
the positioning system is configured to compensate for a gap between a first center and a second center, which is less than or equal to a few micrometers,
the first center indicates a center of a pre-set area to be processed by a laser beam emitted from the laser source, and
the second center indicates a center of an area actually irradiated by the laser beam.

12. The laser processing apparatus of claim 10, wherein the laser source irradiates a laser beam onto an object to be processed disposed on the stage and forms a hole in the object to be processed.

13. The laser processing apparatus of claim 12, wherein the object to be processed has a length of tens of meters and a width of several meters.

14. The laser processing apparatus of claim 10, wherein the flexure is provided in plurality, and the plurality of flexures are spaced apart from each other in the first direction or a second direction that intersects the first direction.

15. The laser processing apparatus of claim 14, wherein the plurality of flexures includes:
a first group of flexures and a second group of flexures, which are spaced apart from each other in the first direction,
the first group of flexures includes a first flexure and a second flexure, which are spaced apart from each other in the second direction, and
the second group of flexures includes a third flexure and a fourth flexure, which are spaced apart from each other in the second direction.

16. The laser processing apparatus of claim 15, wherein at least two of the first flexure, the second flexure, the third flexure, and the fourth flexure have planar shapes different from each other.

17. The laser processing apparatus of claim 15, wherein at least two of the first flexure, the second flexure, the third flexure, and the fourth flexure have different reaction forces under a same applied force.

18. The laser processing apparatus of claim 10, further comprising:
a sensor, which measures position information of the stage.

19. The laser processing apparatus of claim 18, wherein the plurality of drivers operate based on the position information of the stage.

20. The laser processing apparatus of claim 10,
wherein the plurality of drivers includes:
a base;
a rail on the base;
a guide block, which moves along the rail; and
a driving device, which moves the guide block, and
wherein the flexure is disposed between the guide block and the driving device.
